(19) United States
(12) Patent Application Publication
(10) Pub. No.: US 2003/0179684 A1
(43) Pub. Date: Sep. 25, 2003

(54) Optically controlled digital data read/write device

(76) Inventor: Serge Gidon, Murette (FR)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/344,525

(22) PCT Filed: Aug. 20, 2001
(86) PCT No.: PCT/FR01/02633

(30) Foreign Application Priority Data
Aug. 21, 2000 (FR) 0010763

(51) Int. Cl. G11B 9/00

(52) U.S. Cl. 369/126

(57) ABSTRACT

The invention relates to a device for writing/reading digital data, comprising a recording head (10) fixed to a mobile traveller (11) that moves above a recording support (12) on which several tracks are provided, in which this head (10) comprises several microtips (13) operating in parallel, each associated with a guided optical circuit that address tracks of the recording support (12). Each microtip (13) operates in write and read modes. The guided optical circuit associated with each microtip:

in write mode, behaves like a light guide as far as the photosensitive area of the microtip,

in read mode, collects the diffraction signal of the incident wave on the tip,

The guided optical circuits are directly connected to processing circuits (20) through an optical bus (21).

### TECHNICAL FIELD

The present invention relates to a device for writing/reading digital data with optical control. This type of device may be used to make a high-density digital data storage system with high access rates. It may also be used to make an ultra high density near field biochip write/read device.

### STATE OF PRIOR ART

In the remainder of this description, a high-speed data storage device with optical control will be considered as an example embodiment of the invention.

This type of data storage is of overriding importance in the data processing and multimedia fields, and is usually made in binary form, which enables excellent reproducibility of information. The range of storage devices extends from integrated circuits (ROM or RAM memories) with limited storage capacity (megabyte) but enabling high access to data (a few hundred MHz) to magnetic tapes that provide a very large storage volume (petabytes) but which have poor access time performances.

Between these two types of devices, there are disk recording devices which present a compromise between volume and access rate (gigabytes, tens of MHz) with magnetic and/or optical recording techniques:

magnetic recording is based on the orientation of the coercitive field of the domains of a support under the effect of magnetic induction.

Optical recording is based on the modification of the microscopic structure of the recording material by optical heating, for example with the creation of micro-defects (cavities) in a plastic material or local modifications to the physical characteristics of materials with a phase change: for example crystalline/amorphous in the case of RAM DVD devices as described in reference document [1] at the end of the description.

Many developments are under way to increase the storage density and to give good data flow performances. Some methods include:

MSR (Magnetic Super Resolution) or MAMMOS (Magnetic Amplify Magneto-Optical System), magnetic storage methods with concentration of the field within the smallest possible volume,

SIL (Solid Immersion Lens), a purely optical method that uses the optics at the resolution limits and appears quite acceptable for storage on removable supports due to a tolerance of the depth of the optical field, with storage densities limited to 2.5 Gb/in²,

and microtip effect methods that are promising in terms of information storage densities, 30 Gb/in² to 1 Tb/in² being envisaged, particularly:

IBM's micro-mechanics,

STM (Scanning Tunnelling Microscopy),

AFM (Atomic Force Microscopy),

MFM (Magnetic Force Microscopy),

EFM (Electrostatic Force Microscopy),

SNOM (Scanning Optical Near field Microscopy) with its variants:

SIAM (“Scanning Interferometric Apertureless Microscopy”),

SPNM (Scanning Plasmon Near field Microscopy).

These methods are very demanding concerning the cleanliness of the support, requiring the use of dust tight recording cartridges. A comparative analysis of several of these methods is given in document reference [2].

Micromechanical systems with microtips remain limited in data flows by tip, by design. It is impossible to find a compromise between a high mechanical modulation frequency of microtips necessary to follow surface patterns, limited to a few MHz by the inertia of suspension arms, and immunity to parasite vibrations.

As described in document reference [2], only the SNOM optical method and its variants provide high speeds limited only by the quantum noise of the number of photons per bit. However, it requires high optical powers for the recording phase due to a purely optical thermal effect.

Therefore the purpose of the invention is to make a device in which such a compromise is possible, particularly by proposing a digital data storage device that offers large storage capacities and high data exchange rates.

Presentation of the Invention

The invention proposes a device for writing/reading digital data with optical control, comprising a recording head fixed to a mobile traveller that moves above a recording support on which several tracks are provided,

characterised in that this head comprises several microtips operating in parallel, each associated with a guided optical circuit that address tracks of the recording support, in that each microtip operates in write and read modes, in that the guided optical circuit associated with each microtip:

in write mode, behaves like a light guide as far as the photosensitive area of the microtip,

in read mode, collects the diffraction signal of the incident wave on the microtip,

and in that the guided optical circuits are directly connected to a processing unit through an optical bus, for example formed of optic fibres.

Advantageously, each microtip comprises optically controlled Joule heating means to write a memory point onto the recoding support. Each microtip comprises SNOM or SIAM type effect means to read a memory point on the recording support. Each microtip comprises a decoupling capacitance, one electrode of which is integrated within the head, and the other electrode consists of the recording support. Each microtip comprises current control means by photoelectric effect through a semi conducting junction.

In each microtip, the excitation wavelengths may be different in read and write modes. It is also possible for only part of the incident flux to be absorbed in a semi conducting junction of each microtip, the other part being used for detection in read.

In one embodiment, several memory plates may be installed on the same spindles of the recording support.

In one embodiment, the recording support is a memory disk. The recording head is in the form of a pad that flies over the disk surface by the aerodynamic air cushion effect. The head addresses tracks in nested spirals arranged on the disk with head guide marks on the disk distributed around a spiral inserted between all the guide marks. One microtip on the head is dedicated to reading the head guide marks.

In one advantageous embodiment, the head comprises:

microtips embedded in an insulating material that form the base of a pad with an aerodynamic chamfer,

optical guides to bring or pick up light waves close to microtips,

a photosensitive area on each microtip facing each optical guide,

one electrode of the electrical circuit decoupling capacitor, the other electrode being composed of the recording support,

a guide spreader that facilitates easy connection of the head to a strip of connecting fibres leading to the processing unit.

The head may also comprise two networks of micro-lenses facing each other at the output pitch from the spreader, placed at the end of the guides, to enable an elevated interconnection of the head to the layer of fibres.

Advantageously, the mobile traveller includes a suspension arm that holds the pad opposite the recording tracks, with a displacement motor to position the head facing the recording tracks.

Advantageously, the microtips are separated by a minimum distance of 20 μm to avoid any interference between the neighbouring guides of the optical circuit. They are preferably made of silicon doped so as to be conducting and embedded within an insulating material made of silica which may be covered by a layer of silicon nitride or carbide to prevent wear.

In one variant embodiment, an actuator is included in the pad specifically to move the microtips. The pad may be micro-machined to release a mobile traveller on which the microtips are fitted.

In one variant embodiment, each guided optical circuit comprises a means at its end to reflect the wave guide on itself.

The device according to the invention may be used to make a high-density storage device with high data access rate. It may also be used to make an ultra high density near field biochip write/read device.

The device according to the invention has many advantages:

the microtip current is controlled by a current control that is not very sensitive to the fluctuating resistivity of the electrical contact with the recording support,

the optical control is very fast, to the extent that the current may be applied for times of the order of magnitude of the thermal time constant of the material (of the order of a few nanoseconds) which enables controlled heating of the material, without an avalanche phenomenon,

the approach in write mode may appear to be similar to the SNOM method (in which the power is deposited in light form), but is fundamentally different because amplification of the optical power through the photon/electron conversion is used. This amplification overcomes the defect of the SNOM method, which is that a high laser power of a few mW is necessary. This increase in power, which is the ratio of the available electronic heating power to the applied optical power, is equal to the ratio of the energy of the electrons to the energy of the photons. It may be of the same order as the voltage applied to the microtip (20 to 100 for photon energy of the order of one eV; λ=1 μm),

the optical control may be offset by several centimetres, or more with fibres, without risking any electromagnetic coupling between control signals with high modulation frequencies.

### BRIEF DESCRIPTION OF THE DRAWINGS

FIG. 1 diagrammatically illustrates the write/read device according to the invention.

FIG. 2 illustrates the connection of the device according to the invention to an inter-processor optical bus.

FIG. 3 illustrates an example embodiment of a memory disk provided with spiral nested tracks.

FIG. 4 illustrates positioning of microtips of the head in the device according to the invention with respect to the tracks on the memory disk illustrated in FIG. 3.

FIGS. 5A and 5B illustrate a side view and a front view respectively of an embodiment of the device according to the invention; FIG. 5B also illustrates an interconnection with two fibre networks.

FIG. 6 illustrates coupling of an optical guide and a microtip in the device according to the invention.

FIGS. 7A and 7B illustrate a side view and a front view respectively of a variant embodiment of the device according to the invention.

FIG. 8 illustrates another variant embodiment of the device according to the invention.

### DETAILED PRESENTATION OF PARTICULAR EMBODIMENTS

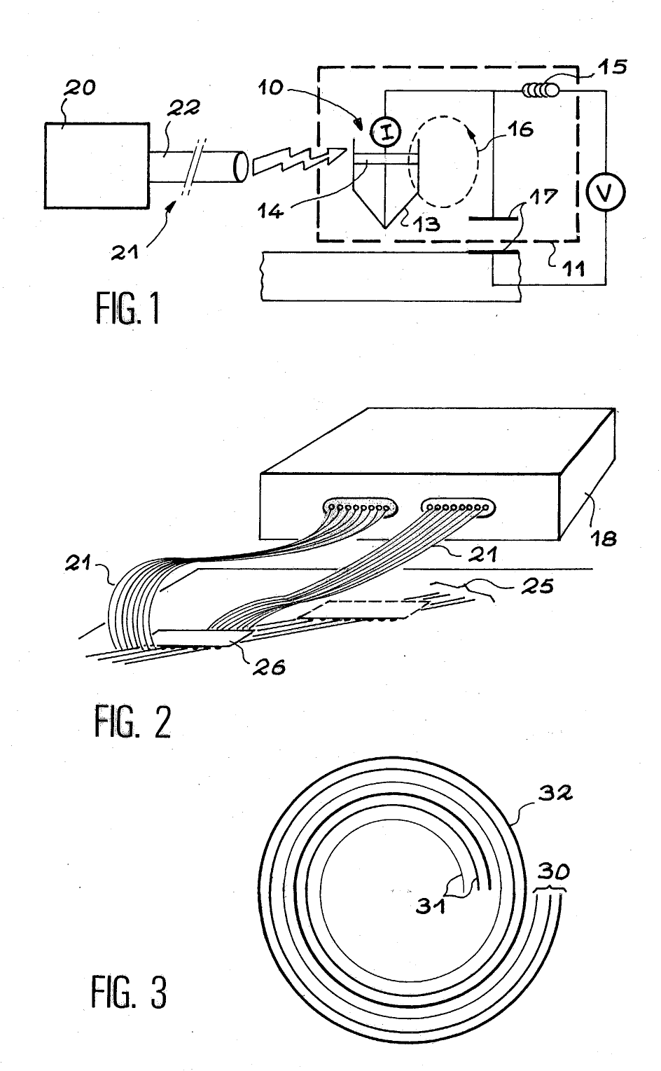

As illustrated in FIG. 1, the device for writing/reading digital data according to the invention comprises a recording head 10 fixed to a mobile traveller 11 that moves above a recording support 12 on which there are several tracks. This head contains several microtips 13 that operate in parallel, each associated with a guided optical circuit that address the tracks of the recording support 12.

Each microtip 13 operates both in write and in read mode.

Each guided optical circuit associated with a microtip 13 behaves in write mode like a light guide as far as a photosensitive area 14 of the microtip 13. The tip effect then used is optically controlled localised Joule heating. The write current is controlled by an optical device, for example a diode (photons source) that illuminates the microtip 13 through an optical guide 22 of an optical bus 21. The microtip is provided with a photo conducting junction 14 to control the current that passes through the microtip, and therefore the temperature rise in the recording support 12 under the microtip 13.

Writing data using a tip effect method can give a very high storage density since the microtip 13 defines the size of the corresponding elementary memory point.

In read mode, the guided optical circuit collects the incident wave diffraction signal on the microtip disturbed by the local characteristics of the material of the support 12 located underneath. A SNOM type effect based on detection of the variation of the amplitude of the analysis wave, or a SIAM type effect which is an interferometric variant of the SNOM type effect based on detection of the variation of the phase of the analysis wave, is then used. In read mode, the same device is used as for write mode. The microtip 13 illuminated by the same diode signal induces an optical echo that is variable as a function of the nature of the material of the support 12 located under this microtip 13. This optical echo is then detected by a photodiode.

In write mode, the current passing through the microtip 13 is controlled. This control is based on the amplitude of the current in the microtip, for example by a photoelectric effect such as the effect that exists within a P/N or PIN semi conducting junction, or any other photo generated effect such as the photo resistance effect. In the device according to the invention, the junction 14 that acts as a photo controlled modulator, forms an integral part of the microtip 13. When it is illuminated, it allows a current to pass, that is usually proportional to the incident photons flux.

A high frequency or HF circuit (HF current loop 16) is confined close to the microtip 13 by means of an electromagnetic decoupling architecture. A polarization source V supplies the energy (current I at voltage V) for writing. A decoupling inductance or resistance 15 isolates the HF circuit consisting of the tip and the decoupling capacitor 17 from the rest of the electronics, by coupling to a decoupling capacitor 17. One of the electrodes of this capacitor 17 is located in a plane of the support of the microtip 13, and the other is formed by the surface of the recording support 12.

The device according to the invention thus integrates several microtips 13 (M) operating in parallel, within the same head. Several memory “plates” (P) can then conventionally be installed on the same spindle of the recording support 12 to increase its storage capacity, so that the optical bus 21 reaches the required degree of parallelism (N=P×M).

To satisfy the requirements for a compromise between absorption of write flux and transmission of the read signal, it is possible to either:

use different tip effect excitation wavelengths for write and read modes. For example, in the case of a junction in silicon (gap at a wave length of about 1 μm), a write wave length shorter than 1 μm is absorbed in the junction 14 and a wave length longer than 1 μm (1.3 mm), the range at which the absorption of silicon is lower, can be used in read mode,

for operation at a single wavelength, the position of the guide 22 with respect to the microtip can be optimised, for example to only absorb part of the incident flux in junction 14, the other part being used for detection in read mode.

As illustrated in FIG. 1, the guided optical circuits are directly connected to a processing unit 20 through the optical bus 21 formed from optical guides 22. The device according to the invention can thus be used to make an interface between the recording support 12 (data storage) and this processing unit 20, the diode and the photodiode considered above being implanted in this processing unit 20.

The passband of the optical bus 21 is sized to give the best data rate. Storage densities are such that if the linear speed of the recording support 12 is equal to several tens of meters per second (typical for conventional recording), binary rates of several hundred MHz can be achieved.

The recording support 12 can be made from any type of conducting material, for example materials with phase change or magnetic materials. In the case of magnetic materials, (conventional) field induction means are placed close to the tips, since the data recording phase is done by the Joule effect.

As illustrated in FIG. 2, the optical bus 21 output from the device according to the invention 18, for example with optic fibres, may be arranged in extension of an optic fibre bus 25 providing optical interconnections between processors, by means of a connector 26. This bus 25 enables processing of binary words by different processors (bus with N lines, where N is usually a multiple of 8; for example 32 or even 64 bits).

In one embodiment illustrated in FIG. 3, the recording support 12 is a memory disk. The microtips head addresses tracks in nested spirals at a spacing of 10 to 200 nm with head guide marks, of the type of those described in document reference [3], themselves distributed in an intermediate spiral. These marks are read by a microtip that may be dedicated to this purpose. FIG. 3 shows an example of three nested tracks 30, including two data tracks 31 and a track 32 on which the head guide marks are arranged.

In this embodiment of the device according to the invention, the microtips 13 are placed very close to the surface of the recording support 12, typically a few tens of nanometers. These microtips 13 are integrated within a recording head 10 in the form of an aerodynamic pad that “flies” over the surface of the recording support under relative speed conditions, by an air cushion effect. This type of solution is described in document reference [4], for conventional recording. A suspension arm holds the pad with respect to the recording tracks with a displacement motor to position the head facing the recording tracks.

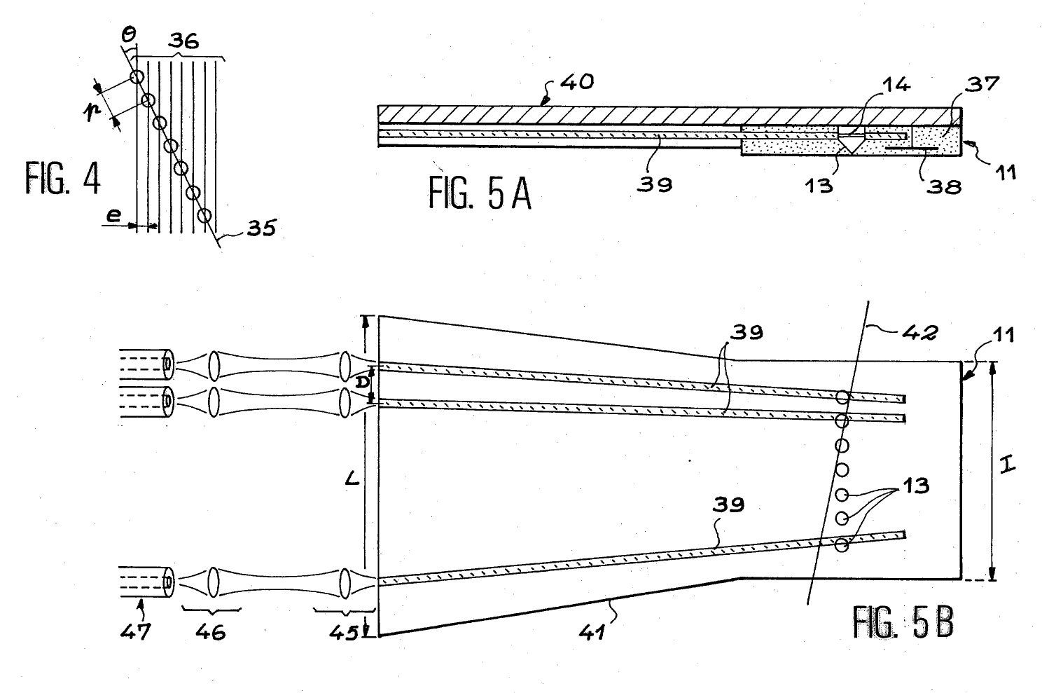

As illustrated in FIG. 4, the microtips 13 are separated by a minimum distance p of about 20 μm to prevent any interference between the adjacent guides of the optical circuit. To achieve the required storage density per unit surface area (proximity of tracks on the recording support from 10 to 500 nm), the alignment axis 35 of the microtips 13 with respect to the tangential direction of the tracks 36 is inclined at an angle θ. The separation distance e between the tracks is then directly related to the pitch p of the microtips 13 by the relation sin θ=e/p. In practice, the angle θ is of the order of a few tens of minutes. A head positioning system can achieve this precision.

As illustrated in FIGS. 5A and 5B, the head 10 comprises the following elements:

the microtips 13 embedded in an insulating material 37 that form the base of the pad 11 provided with an aerodynamic chamfer,

optical guides 39 to bring or take away light waves close to the microtips 13 passing through the arm 40,

photosensitive areas 14 of these microtips 13 facing these guides 39,

one electrode 38 of the decoupling capacitor 17, the other electrode consisting of the surface of the recording support 12,

a guide spreader 41, that enables easy interconnection of the head to a strip 47 of connecting fibres leading to the processing unit 20. The spacing D of the guides 39 at the exit from the spreader 41 is typically 250 μm (or even 125 μm), distributed on a zone L whereas the microtips 13 are at a distance of about 20 μm and are distributed over a distance I, where the line 42 is the line along the direction of the tracks on the recording support. The spreader 41 in which the guides are not necessarily straight as shown, is designed to minimize propagation losses,

possibly two networks 45 and 46 of micro-lenses facing each other at the output pitch D of the spreader, placed at the end of the guides as illustrated in FIG. 5B, to enable an elevated interconnection of the head to the fibres strip 47.

This type of interconnection of the head to the optical bus of the system (fibre strips 47), by elevated means (networks 45 and 46) has the advantage compared with a direct connection between the fibre strip 47 and the head, that it reduces the inertia of the mobile traveller by dematerialising transport of light between the head and the optical bus. The distance between the two lens networks 45 and 46 depends on the position of the head above the disk.

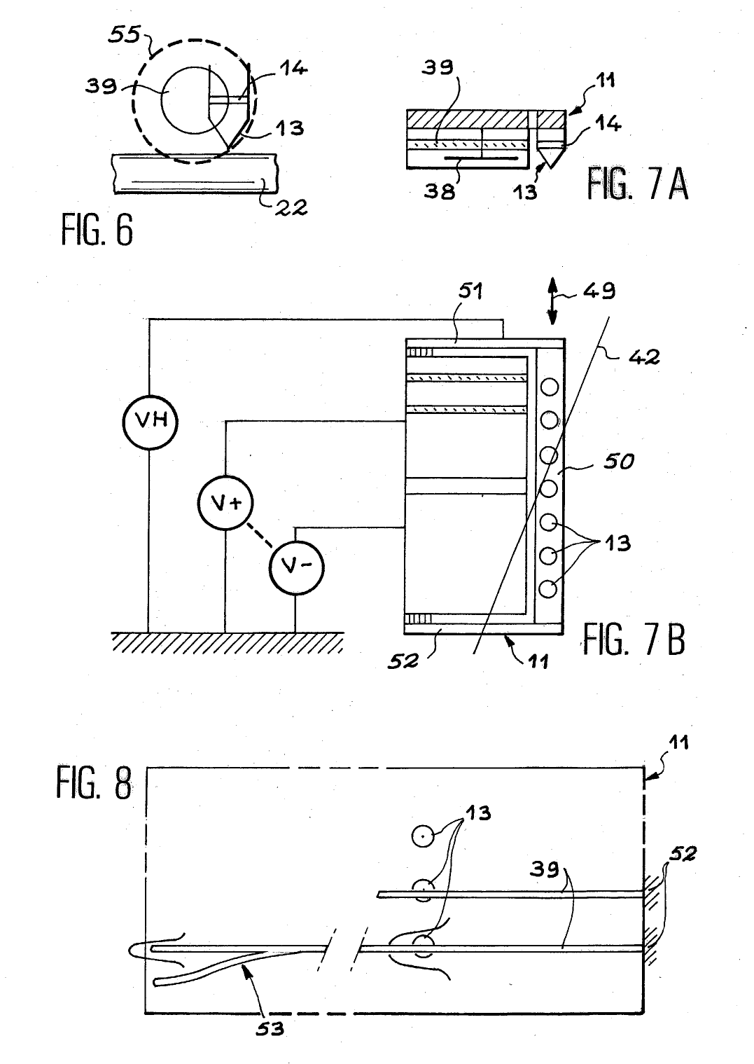

FIG. 6 shows the evanescent wave 55 that exists around an optical guide 39. It extends over a few micrometers and surrounds the corresponding microtip 13. The guide 39 may be sharpened to adjust coupling with the microtip.

The microtips 13 are advantageously made of silicon and are incorporated in an insulating material 37 such as silica, possibly covered by a layer of hard material to prevent wear such as a silicon nitride or carbide according to conventional micro-electronics processes as described in document reference [5]. Different methods can be used to make the microtips as described in document reference [6].

The PN or PIN semi conducting junction 14 in the microtip 13 may be made of silicon by implantation (N or P complementary doping), possibly by epitaxy.

In one variant embodiment illustrated in FIGS. 7A and 7B, the pad 11, in this case shown without the spreader 41, comprises an actuator to displace the microtips 13 along a direction 49 and thus reduce the positioning inertia of the microtips facing the tracks of the recording support. This actuator is advantageously made using the MEMS (Micro Electro Mechanical Systems) technology.

The pad 11 is then micro-machined to release a mobile traveller 50 that carries the microtips. The suspension arms 51 and 52 of the traveller 50 are preferably made of silicon (elastic and deformable material) that is also doped, and can therefore be used to make facing electrodes for an electrostatic actuator. Silica, that forms the base of the pad 11, is used to assemble the different elements made of silicon (electrodes) with an insulating material.

The electrostatic actuator is moved by simultaneous application of a V+ voltage on one of the electrodes and a V− opposite voltage on the symmetrical opposite electrode.

Since a voltage VH (from 20 to 100 V) is applied to the microtips 13, electrostatic forces exist on the two symmetrical electrodes with a value proportional to the square of the difference in voltage namely F=k(ΔV)² (as an approximation, it is assumed that there is a proportionality coefficient k that depends on the characteristics of the facing electrodes), giving the following for the two suspension arms 51 and 52:

F1=k(VH−V+)²

F2=k(VH−V−)²=k(VH+V+)²

The result for the forces is equal to:

F1−F2=4 k VH.V if V=V+=V−

Considering the high value of the voltage VH, a small analogue modulation of V will cause a significant displacement of the mobile traveller 50 (1 to 2 μm along the direction 49 of the microtips 49). The displacement of the microtips 13 with respect to the tracks is factored by the sine of the angle θ (tangential displacement). Thus, the resulting positioning precision is measured in nanometers.

In one variant embodiment shown in FIG. 8, the detection signal in read can be optimised by providing each optical guide 39 with a means 52 at its end to reflect the guided wave on itself, for example a cleavage mirror or a network on guide. The reflection capacity of this mirror is optimised for the two detection modes considered (SNOM and SIAM modes). In SNOM mode (detection in amplitude variation), this mirror 52 is used as a reflector for operation in double passage, and is therefore very reflecting. In SIAM mode (detection of phase variation), this mirror is used to return a reference signal. Its reflecting capacity is then chosen to optimise a modulation rate (10%).

If the head comprises a mobile microtips traveller, it is also possible in interferometric detection mode (SIAM) to use the parasite reflection existing at the guides interface just before the microtips, as a phase reference signal.

The reflected wave, that carries read information from the microtips, may be determined by disturbance of the impedance of the emission source (laser diodes) or by photodiode detection, after separation of the initial wave (counter-propagative) by any directional optical means such as a Y separator 53 or a directional coupler that can be integrated into the head as shown in FIG. 8.

### REFERENCES

[1] “Rare earth transition metal alloys for magneto-optical recording”, J. Daval and B. Bechevet (Journal of Magnesium and Magnetic Materials 129, 1994, pages 98 to 107).

[2] “SPM base storage” by S. Hosaka (IEEE Trans. Magnetics, vol. 32, No. 3, May 1996).

[3] “Atomic force microscope-based storage track servo and wear study” by B. D. Terris, S. A. Rishton, H. J. Mamin, R. P. Ried and D. Rugar (Applied Phys. A 66, S809-813, 1998).

[4] “Near field optical data storage” by B. D. Terris, H. J. Mamin and D. Rugar (Applied Phys. Letter 68, pages 141 to 143, January 1996).

[5] “Si-based integrated optics technologies”, by S. Valette, J. P. Jadot, P. Gidon, S. Renard, A. Fournier, A. M. Grouillet, H. Denis, P. Philippe and E. Desgranges (Solid St. Technol., pages 69 to 74, February 1989).

[6] “Use of Plasma processes for the fabrication of metal and silicon microtips cathodes” by R. Baptist (CIP 97, 11^{th} International Colloquium on Plasma Processes, May 25-29, 1997, Le Mans, France, Proceedings, SFV).

1. Device for writing/reading digital data with optical control, comprising a recording head (10) fixed to a mobile traveller (11) that moves above a recording support (12) on which several tracks are provided,
characterised in that this head (10) comprises several microtips (13) operating in parallel, each associated with a guided optical circuit that address tracks of the recording support (12),
in that each microtip (13) operates in write and read modes, in that the guided optical circuit associated with each microtip:
in write mode, behaves like a light guide as far as the photosensitive area of the microtip,
in read mode, collects the diffraction signal of the incident wave on the microtip, and in that the guided optical circuits are directly connected to a processing unit (20) through an optical bus (21).

2. Device according to claim 1, in which the optical bus (21) is formed of optic fibres (22).

3. Device according to claim 1, in which each microtip (13) comprises localized optically controlled Joule heating means to write a memory point onto the recording support (12).

4. Device according to claim 1, in which each microtip (13) comprises SNOM or SIAM type effect means to read a memory point on the recording support (12).

5. Device according to claim 1, in which each microtip (13) comprises a decoupling capacitor (17), of which one electrode is integrated into the head and the other electrode is composed of the recording support (12) and a decoupling inductance or resistance (17).

6. Device according to claim 1, in which each microtip (13) comprises current control means by photoelectric effect.

7. Device according to claim 5, in which each microtip (13) comprises a semi conducting junction (14).

8. Device according to claim 1, in which the excitation wavelengths in each microtip are different in read mode and in write mode.

9. Device according to claim 1, in which only part of the incident flux is absorbed in a semi conducting junction (14) of each microtip, the other part being used in read detection.

10. Device according to claim 1, in which several memory plates are installed on the same recording support spindles (12).

11. Device according to claim 1, in which the recording support (12) is a memory disk.

12. Device according to claim 11, in which the head (10) addresses nested spiral tracks (31) arranged on the memory disk with head guide marks on the memory disk distributed in an intermediate spiral (32).

13. Device according to claim 12, in which a head microtip is dedicated to reading head guide marks.

14. Device according to claim 11, in which the recording head (10) is in the shape of an aerodynamically shaped pad which flies above the surface of the memory disk by an air cushion effect.

15. Device according to claim 14, in which the head (10) comprises:
microtips (13) embedded in an insulating material (37) that forms the base of the pad,
optical guides (39) to bring or pick up light waves close to microtips (13),
a photosensitive area (14) on each microtip facing each optical guide (39),
one electrode of the decoupling capacitor (17), the other electrode being composed of the recording support (12),
a guide spreader (41).

16. Device according to claim 15, in which the head (10) comprises two networks (45, 46) of micro-lenses facing each other at the output pitch from the spreader (41), placed at the end of the guides.

17. Device according to claim 14, in which the mobile traveller (11) comprises a suspension arm that holds the pad facing the tracks of the recording support, with a translation motor to position the head facing these tracks.

18. Device according to claim 15, in which the microtips (13) are separated by a minimum distance of 20 μm.

19. Device according to claim 15, in which the microtips (13) are made from silicon, and are embedded in a silica insulating material (37).

20. Device according to claim 19, in which the silica is covered by a layer of silicon nitride.

21. Device according to claim 14, in which an actuator is integrated into the pad (11) to displace the microtips.

22. Device according to claim 21, in which the pad (11) is micro-machined to release a mobile traveller (50) carrying the microtips (13).

23. Device according to claim 1, in which each guided optical circuit comprises a means at its end to reflect the guided wave on itself.

24. Device according to any one of the previous claims, used to make a high-density storage device with a high data access rate.

25. Device according to any one of claims 1 to 23, used to make an ultra high density near field biochip write/read device.
